(19) United States
(12) Patent Application Publication
(10) Pub. No.: US 2007/0223841 A1
(43) Pub. Date: Sep. 27, 2007

(54) METHODS OF CHARACTERIZING THE PROBABILITY OF WIND IMPACT

(76) Inventors: Robert Andrew Weinzapfel, Richmond, TX (US); Christopher Gerard Hebert, Houston, TX (US); Mark Allan Chambers, Friendswood, TX (US)

Correspondence Address: PATTERSON & SHERIDAN, L.L.P., 3040 POST OAK BOULEVARD, SUITE 1500, HOUSTON, TX, 77056, US

(21) Appl. No.: 11/690,069

(22) Filed: Mar. 22, 2007

Related U.S. Application Data
(60) Provisional application No. 60/785,179, filed on Mar. 23, 2006.

(51) Int. Cl. G06K 9/00

(52) U.S. Cl. 382/325

(57) ABSTRACT

At least one method for indicating a weather condition. The method includes providing a probability of one or more wind fields from a cyclone impacting one or more locations over a period of time. The probability may then be delivered to a recipient.

### CROSS-REFERENCE TO RELATED APPLICATIONS

This application claims benefit of U.S. Provisional Patent Application Ser. No. 60/785,179, filed Mar. 23, 2006. The U.S. Provisional Patent Application Ser. No. 60/785,179 is incorporated herein in its entirety.

### BACKGROUND

1. Field of the Method

This application relates to one or more methods for characterizing storms and defining a threat from a cyclone.

2. Description of the Related Art

Various approaches for characterizing storms have been used in the past. One tropical cyclone characterization method includes forming the Saffir-Simpson Hurricane Scale (SSHS). The SSHS approach involves classifying those intense tropical cyclones called hurricanes, which contain maximum sustained winds of greater than or equal to 74 mph on a scale of 1-5 based on the intensity of their maximum sustained winds. Each category has a range of maximum sustained winds with a Category 5 Hurricane having wind speeds greater than 155 mph. The SSHS describes typical wind damage and storm surge characteristics that one might expect from each category of hurricane. The SSHS only takes into account the sustained wind speed and does not use any other parameters to assign a category. The SSHS also does not classify tropical cyclones that contain sustained winds of less than 74 mph which include tropical storms (winds 39-73 mph) and tropical depressions (winds <39 mph).

Additional examples of prior art are listed on the face of the patent. The methods described below overcome one or more of the shortcomings found in the prior art methods and devices.

### SUMMARY

This application relates to one or more methods for characterizing storms. For example, a method of characterizing a storm can include combining a first storm parameter with a second storm parameter to provide an index. Further examples include a method of characterizing a storm wherein one parameter is a size parameter.

The intensity of a cyclone alone is not adequate for a detailed characterization of its severity. The size of a storm is also an important factor. A larger cyclone will produce a wider area of significant damaging winds than a smaller cyclone. The storm surge from a cyclone can vary dramatically between two cyclones having the same maximum sustained winds but varying sized wind fields. Accordingly, at least one embodiment includes using both size and intensity parameters to form an index.

An enhanced cyclone rating system can more accurately define the strength and destructive capability of a given storm than other scales currently used. The Hurricane Severity Index can use comprehensive equations which incorporate not only the wind speed but also the size of the area the winds cover. At least one specific and tangible value of the new index is that it can provide clients, forecasters and other weather watchers a much clearer idea of the threat imposed by an approaching storm. Utilizing a scale of 1 through 50, (e.g., in an embodiment) a new index described herein can more clearly differentiate and illustrate what can be expected in the target region from a hurricane. The methods can assess the many factors that truly determine the destructive potential of a cyclone. The methods can categorize and communicate the extent or the degree of the threat posed by a cyclone by considering more factors than just maximum sustained winds.

A method of indicating a weather condition may be provided. The method includes providing a probability of a wind field from a cyclone impacting one or more locations over a period of time. The method may further include delivering the probability of the wind field impact to a recipient.

A method of preparing an insurance index may be provided. The method includes providing a probability of a wind field from a cyclone impacting one or more locations over a period of time and delivering the probability of the wind field impact to a recipient. The next step in the method may include preparing an insurance index based on the probability of impact.

### BRIEF DESCRIPTION OF THE DRAWINGS

The Figures include the following.

FIG. 1 is a flow chart depicting a prior art method for calculating a storm index.

FIG. 2 is a flow chart depicting a method for calculating a storm index.

FIG. 3 is a flow chart depicting a method for calculating a storm index.

FIG. 4 is a graph depicting one of the parameters.

FIG. 5 is a graph depicting one of the parameters.

FIG. 6 is a flow chart depicting a method for calculating a probability of impact.

FIG. 7 is a flow chart depicting a method for calculating a probability of impact.

FIG. 8 is a chart depicting a storm track.

FIG. 9 is a statistical distribution of a cyclone.

FIG. 10 is a table.

FIG. 11 is a flow chart depicting a method for delivering a probability of wind impact.

FIG. 12 is a chart depicting a storm track.

FIG. 13 is a table.

FIG. 14 is a chart.

FIG. 15 is a flow chart depicting a method for delivering a worst case scenario to a recipient.

FIG. 16 is a chart depicting a storm track.

FIG. 17 is a table.

FIG. 18 is a flow chart depicting a method for indicating a weather condition.

FIG. 19 is a chart depicting a storm track.

### DETAILED DESCRIPTION

A detailed description will now be provided. A variety of embodiments relate to various methods for characterizing cyclones. Further, embodiments relate to methods for indicating weather conditions from cyclones. The cyclones are characterized using one or more parameters. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art of weather forecasting to practice and use the inventions, when the information in this patent is combined with available information and technology. Various terms as used herein are defined below.

“Characterizing” is defined herein to include using qualities. Examples of characterizing include, but are not limited to: indexing, classifying, describing, allocating, analyzing, arranging, assorting, breaking down, cataloguing, codifying, coordinating, grading, distinguishing, ranking, organizing, ordering, labeling, grouping, and filing.

“Cyclone” is defined herein to include any cyclonically rotating storm or storm system. Examples of cyclones include, but are not limited to: hurricanes, cyclones, tropical cyclones, tropical storms, tropical depressions, typhoons, supertyphoons, subtropical cyclones, subtropical depressions, subtropical storms, extratropical low, midlatitude low, polar low, kona low and severe tropical cyclones.

“Tropical Cyclone” is defined herein to include any cyclonically rotating storm or storm system of tropical origin. Examples of tropical cyclones include, but are not limited to: tropical storms, tropical depressions, typhoons, supertyphoons, tropical lows, subtropical cyclones, subtropical depressions, subtropical storms, subtropical lows, cyclones, and severe tropical cyclones. The aforementioned terms may overlap in meaning.

“Subtropical Cyclone” is defined herein to include any weather system that is a cyclonically rotating storm or storm system and has both tropical and non-tropical characteristics. Examples of tropical cyclones include, but are not limited to: subtropical lows, subtropical storms, and subtropical depressions. The aforementioned terms may overlap in meaning.

“Storm” is defined herein to include any cyclonically rotating weather system of tropical, subtropical, extratropical, or polar origin with a circulation encompassing a large area, for example greater than 100 km. Examples of storms include, but are not limited to: hurricanes, cyclones, tropical cyclones, tropical storms, tropical depressions, typhoons, supertyphoons, subtropical cyclones, subtropical depressions, subtropical storms, extratropical low, midlatitude low, polar low, and kona low. The aforementioned terms may overlap in meaning.

“Significant Disturbance” is defined herein to include any organized area of convection (thunderstorms) of tropical or subtropical origin which has a reasonable chance of developing into a cyclone at some point in the future. Examples of a significant disturbance include, but are not limited to: African easterly wave or waves, frontal zone or zones, subtropical low centers, upper-level troughs, monsoons throughs, or any convective complex that is located over or projected to move over tropical or subtropical waters.

“Weather” is defined herein to include the state of the atmosphere with respect to at least wind. Examples of weather include, but are not limited to: temperature, cloudiness, moisture, pressure, wind speed and direction, storm, storms, meteorological outlook, and precipitation.

“Condition” is defined herein to include the state or situation of a thing with respect to circumstances. Examples of a condition include, but are not limited to: a quality, situation, shape, sphere, standing, state, status, appearance, aspect, form, health, phase, bearing, case, mode, order, plight, and position.

“Impact” is defined herein to include the effect of one thing on another thing. Examples of impact include, but are not limited to: collision, strike, clash, contact, crash, encounter, hit, force, impingement, meet, ram, shock, and smash.

“Area” is defined herein to include any particular extent of space or surface, a geographical region. Examples of area include, but are not limited to: breadth, expanse, field, distance, compass, range, scope, size, space, sphere, and domain.

“Combining” is defined herein to include bringing together or merging. Examples of combining include, but are not limited to: accumulating, aggregating, assembling, collecting, compiling, consolidating, gathering, incorporating, joining, and unifying.

“Indicating” is defined herein to include pointing out or directing attention to. Examples of indicating include, but are not limited to: showing, pointing out, stating, relating, quoting, mentioning, noting, implicating, associating, attributing, citing, and connecting.

“Providing” is defined herein to include making available to or furnishing. Examples of providing include, but are not limited to: supplying, stocking, procuring, outlining, catering, equipping, and delivering.

“Delivering” is defined herein to include turning over or supplying to. Examples of delivering include, but are not limited to: giving, distributing, carrying out, conveying, handing over, hand carrying, passing, transporting, granting, transferring, yielding, dealing, dispatching, sending, transmitting, doling, furnishing, issuing, providing, serving, emailing, phoning, wiring, faxing, and tendering.

“Calculating” is defined herein to include determining or ascertaining by mathematical methods, or computing. Examples of calculating include, but are not limited to: adding, multiplying, subtracting, dividing, deriving, accounting, adjusting, appraising, ciphering, considering, counting, enumerating, figuring, forecasting, gauging, judging, tabulating, measuring, numbering, rating, summing, and tallying.

“Displaying” is defined herein to include showing or making visible. Examples of displaying include, but are not limited to: baring, brandishing, demonstrating, disclosing, exhibiting, exposing, featuring, illustrating, imparting, making known, manifesting, presenting, publishing, representing, revealing, showcasing, and unveiling.

“Sending” is defined herein to include causing to be conveyed or transmitting. Examples of sending include, but are not limited to: broadcasting, casting, advancing, communicating, delegating, delivering, directing, disseminating, dispatching, emitting, forwarding, giving, granting, imparting, issuing, mailing, propelling, radiating, remitting, routing, shipping, televising, wiring, phoning, faxing, emailing.

“Evacuating” is defined herein to include removing persons and/or things from a place. Examples of evacuating include, but are not limited to: abandoning, clearing, bailing out, departing, deserting, discharging, ejecting, expelling, leaving, moving out, packing up, pulling out, shutting down, relinquishing, vacating, withdrawing, escaping, exiting, getting away, going away, and migrating.

“Impacting” is defined herein to include affecting one thing with another thing. Examples of impacting include, but are not limited to: affecting, colliding, striking, clashing, contacting, crashing, encountering, hitting, forcing, impinging, meeting, ramming, shocking, and smashing.

“Receiving” is defined herein to include taking into possession or acquiring. Examples of receiving include, but are not limited to: accepting, admitting, apprehending, appropriating, arrogating, assuming, being given, being informed, being told, catching, collecting, deriving, gaining, getting, obtaining, procuring, reaping, securing, and taking.

“Parameter” is defined herein to include any value that is or includes a number, preferably one capable of being part of a calculation. Examples of a parameter include, but are not limited to: a constant, criterion, characteristic, limitation, restriction, specification, aspect, attribute, condition, description, element, factor, feature, property, and trait.

“Intensity” is defined herein to include a concentration, power, or force. Examples of intensity include, but are not limited to: force, forcefulness, concentration, energy, ferocity, magnitude, might, power, severity, and strength.

“Size” is defined herein to include the physical dimensions, proportions, magnitude, or extent of something for example, a cyclone. Examples of size include, but are not limited to: amount, area, bigness, body, breadth, bulk, caliber, capacity, content, diameter, dimensions, enormity, extent, immensity, largeness, length, magnitude, mass, measurement, proportions, range, scope, spread, stature, stretch, substance, tonnage, vastness, volume, and width.

“Index” is defined herein to include any set of data. Examples of an index include, but are not limited to: a curve, plot, graph, guide, indicant, indication, indicator, indicia, mark, model, sign, table, and symbol.

“Algorithm” is defined herein to include any equation or expression that defines a relationship between one or more values. It may include one or more equations, or one or more decisions.

“Probability” is defined herein to include a likelihood or chance of something occurring. Examples of a probability include, but are not limited to: chance, conceivability, contingency, expectation, likeliness, odds, plausibility, possibility, prospect,

“Location” is defined herein to include a place of an activity, business, settlement or residence. Examples of a location include, but are not limited to: area, belt, district, domain, home, business, locality, neighborhood, place, point, position, region, sector, site, spot, territory, tract, venue, vicinity, zone, domicile, dwelling, headquarters, house, living quarters, lodging, street, city, town, drilling rig, offshore platform, boat, ship, and village.

“Recipient” is defined herein to include one or more persons or entities that receive. Examples of a recipient include, but are not limited to: grantee, donee, devisee, payee, customer, user, and receiver.

“Wind” is defined herein to include air in natural motion, as that moving horizontally at any velocity along the earth's surface and in the atmosphere. Examples of a wind include, but are not limited to: blow, air, blast, breeze, Chinook, draft, draught, cyclone, gale, gust, monsoon, tempest, typhoon, wafting, and whirlwind.

“Speed” is defined herein to include rapidity in moving, going, traveling. Examples of speed include, but are not limited to: rate, velocity, clip, fleetness, headway, pace, and rapidness.

“Track” is defined herein to include a course of travel or motion. Examples of a track include, but are not limited to: direction, trajectory, lane, line, passage, route, and alley.

“Cone” is defined herein to include a plane surface generated by two lines extending at an angle from a vertex, or anything substantially shaped like a cone.

“Uncertainty” is defined herein to include the estimated amount or percentage by which an observed or calculated value may differ from the true value.

“Latitude” is defined herein to include the angular distance north or south from the equator of a point on the Earth's surface, measured on the meridian of the point

“Longitude” is defined herein to include the angular distance east or west on the Earth's surface, measured by the angle contained between the meridian of a particular place and some prime meridian, as that of Greenwich, England, and expressed either in degrees or by some corresponding difference in time.

“Forecast” is defined herein to include to predict a future condition or occurrence. Examples of a forecast include, but are not limited to: anticipate, calculate, cast, estimate, foresee, foretell, projection, general outlook and prediction.

“Map” is defined herein to include a representation on a surface of the features of an area of the Earth, showing them in their respective forms, sizes, and relationships.

“Graphically” is defined herein to include pertaining to the use of diagrams, graphs, mathematical curves or the like to represent information. “Indicator” means a person or thing that points out or directs attention to a condition. Examples of an indicator include, but are not limited to: indicia, mark, needle, pointer, ratio, sign, symbol, token, clue, brand, code, cue, explanation, a notation, a cite, and guide.

“Field” is defined herein to include an expanse of anything, or any region characterized by a particular feature, resource, condition, or activity.

“Particular” is defined herein to include of or pertaining to a single or specific person, thing, group, class, occasion, etc., rather than to others or all.

“Condition” is defined herein to include a particular mode of being of a thing, person or event, the existing state.

“Radial” is defined herein to include made in the direction of a radius; going from the center outward or from the circumference inward substantially along a radius.

“Center” is defined herein to include the middle point, or a location substantially in the middle of an item. “Minimum” means the least quantity of amount possible, assignable, allowable, or the like. The lowest amount, value, or degree attained, or recorded.

“Maximum” is defined herein to include the greatest quantity of amount possible, assignable, allowable, or the like. The greatest amount, value, or degree attained, or recorded.

“Travel” is defined herein to include to move or go from one place or point to another, or to proceed or advance in any direction. Examples of travel include, but are not limited to: move, cross, go, proceed, progress, and traverse.

“Customer” is defined herein to include one or more persons or entities that purchase or may purchase goods or services from another. Examples of a customer include, but are not limited to: client, clientele, consumer, patron, prospect, shopper, viewer, and subscriber.

“User” is defined herein to include one or more persons or entities that use a service, or product.

“Distance” is defined herein to include the extent or amount of space between two things, points, lines, etc.

“Straight” is defined herein to include without a substantial bend, angle, or curve; direct.

“Deliverable” is defined herein to include capable of delivery, something such as merchandise or services, that is or can be delivered.

Terms not defined herein have their broadest meaning assigned to them in the Glossary of Meteorology, Second Edition, published by the American Meteorological Society in 2000 and the Webster's New Universal Unabridged Dictionary, Second Edition, published by Dorset & Baber in 1983. To the extent a term used in a claim is not defined herein, it should be given the broadest definition persons in the pertinent art have given that term as reflected in printed publications and issued patents.

### Specific Embodiments

Preferably the methods described herein relate to tropical cyclones; however, it should be appreciated that the methods may be used with any storm. A tropical cyclone is a general term for an area of low pressure that originates over the tropical oceans. The term “tropical cyclone” encompasses tropical depressions, tropical storms, hurricanes, and typhoons. At maturity, a tropical cyclone is one of the most intense and feared storms of the world; winds exceeding 90 m s-1(175 knots) have been measured, and its rains are torrential. Tropical cyclones are initiated by a large variety of disturbances, including easterly waves and monsoon troughs. Once formed, they are maintained by the extraction of latent heat from the ocean at high temperature and heat export at the low temperatures of the tropical upper troposphere. After formation, tropical cyclones usually move to the west and generally slightly poleward, then may “recurve,” that is, move into the midlatitude westerlies and back toward the east. Not all tropical cyclones recurve. Many dissipate after entering a continent in the Tropics, and a smaller number die over the tropical oceans. Tropical cyclones are more nearly circularly symmetric than are frontal or extratropical cyclones. Fully mature tropical cyclones range in diameter from 100 to well over 1000 km. The surface winds spiral inward cyclonically, becoming more nearly circular near the center. The wind field pattern is that of a circularly symmetric spiral added to a straight current in the direction of propagation of the cyclone. The winds do not converge toward a point but rather become, ultimately, roughly tangent to a circle bounding the eye of the storm. Pressure gradients, and resulting winds, are nearly always much stronger than those of extratropical storms. The cloud and rain patterns vary from storm to storm, but in general there are spiral bands in the outer vortex, while the most intense rain and winds occur in the eyewall. Occasionally, multiple eyewalls occur and evolve through a concentric eyewall cycle. Tropical cyclones are experienced in several areas of the world. In general, they form over the tropical oceans (except the eastern South Pacific) and affect the eastern and equatorward portions of the continents. They occur in the North Atlantic (including the Caribbean Sea and Gulf of Mexico), the North Pacific off the west coast of Mexico and occasionally as far west as Hawaii, the western North Pacific (including the Philippine Islands and the China Sea), the Bay of Bengal and the Arabian Sea, the southern Indian Ocean off the coasts of Madagascar and the northwest coast of Australia, and the South Pacific Ocean from the east coast of Australia to about 140°W. In rare cases, tropical cyclones have been observed in the South Atlantic Ocean. By international agreement, tropical cyclones have been classified according to their intensity as follows: 1) tropical depression, with winds up to 17 m s-1(34 knots); 2) tropical storm, with winds of 18-32 m s-1(35-63 knots); and 3) severe tropical cyclone, hurricane or typhoon, with winds of 33 m s-1(64 knots) or higher. It should be noted that the wind speeds referred to above are 10-min average wind speeds at standard anemometer level (10 m), except that in the United States, 1-min average wind speeds are used.

One or more methods described herein include a method of characterizing a storm (e.g., tropical cyclone) by combining a first parameter with a second parameter to provide an index. The first parameter is or may be associated with wind speed. The wind speed parameter may have an exponential relationship to the wind speed. Thus, as the wind speed increases (e.g. over time, or by location), the wind speed parameter increases at a greater rate. The second parameter may be any contemplated parameter including a size parameter, which is preferred. The first and second parameters may be combined to provide an index.

Alternatively, the first parameter may be a size parameter. The size parameter accounts for the size of the tropical cyclone. The size parameter may be calculated using any method. The size parameter may have an exponential relationship to the size of the tropical cyclone. Thus, as the size of the tropical cyclone increases, the size parameter increases at a greater rate. The second parameter may be any contemplated parameter including an intensity parameter. The first and second parameters may then be combined to provide an index.

The methods described herein may be combined with any additional parameters in order to provide an index. Examples of additional parameters include, but are not limited to: minimum sea level pressure, flight level winds, whether winds/intensity are increasing/decreasing, speed of movement, rainfall potential, direction of movement, population at projected landfall, population at current location, potential for flooding at projected landfall/current location. Any combination of parameters may be used in order to generate an index.

One method may include a method of characterizing a storm having a wind intensity parameter with a non-linear relationship to wind speed to provide an index. Thus, the wind intensity parameter increases in a disproportionate manner in relation to the wind speed. The wind intensity parameter may be weighted more heavily as the wind speed increases. This corresponds with the force and damage created by the wind. As the wind speed increases the amount of force and damage potential increases disproportionately to the actual speed increase.

Another method may include a method of characterizing a tropical cyclone having a size parameter with a non-linear relation to the size of the tropical cyclone to provide an index, or storm index. Thus, the size parameter increases in a disproportionate manner in relation with the actual size of the tropical cyclone. The size parameter is weighted more heavily as the size of the tropical cyclone increases. This corresponds with the damage created by the tropical cyclone. As the tropical cyclone size increases, the amount of damage increases disproportionately to the size increase.

A method of characterizing a tropical cyclone may include providing a storm index that includes an intensity parameter. The intensity parameter may be calculated based upon a wind speed, wherein the intensity parameter has an exponential relationship to the wind speed. The intensity parameter may be used alone to form a storm index. Further, the intensity parameter may be used in combination with any number of parameters to form a storm index.

The intensity parameter may be calculated by dividing the wind speed by a constant then raising the result to a power. The result may be raised to any power, for example squared, cubed, etc.

The intensity parameter may be based on a known index, for example, but not limited to, the SSHS.

The index may be used to categorize historical tropical cyclone. Further, the index may be used to characterize existing tropical cyclone as they progress or the index may be used to predict future tropical cyclone progression. The index may be used to characterize and/or predict future tropical cyclone.

The index may be presented in a format that is displayed. The displayed index may be shown as a single index or in conjunction with any number of additional displayed items. The additional displayed items, for example may include, but are not limited to: other storm indices, the SSHS, satellite image of a storm, an infrared image of a storm, historical storm data, historical storm images, a representation of a storm, or other displayed items described herein. The index may be displayed on, but not limited to: a television, a screen, a computer monitor, a newspaper, a book, a magazine, any printed item, a website, a phone, a hand held device, an MP3 player, an email.

A computer may be used to track the storm index in real time. Models for predicting damage and landfall may be derived using the methods described herein.

Any of the methods described herein may be used in conjunction with insurance decisions.

Methods Depicted in Figures

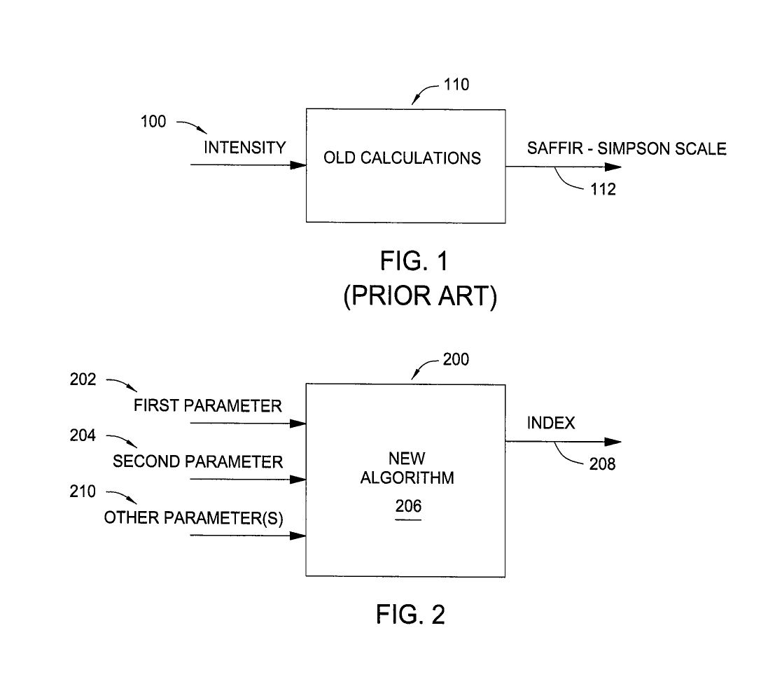

FIG. 1 depicts an example of a prior art methodology for generating current storm indices, namely the Saffir-Simpson Hurricane Scale. An intensity 100 of the wind created by a storm is entered into a calculation 110. The intensity 100 of the wind that is used in the Saffir-Simpson Hurricane Scale is the maximum sustained wind of the storm. The result is a scale 112 having five categories which characterizes the sustained wind and storm surge for the storm.

FIG. 2 depicts a schematic view of a tropical cyclone characterization method 200. As shown, the method 200 includes providing a first parameter 202 and a second parameter 204 to an algorithm 206. The algorithm 206 is then performed and the result of the algorithm 206 is an index 208. Any number of additional parameters 210 may be included with the first and second parameters 202, 204 in order to arrive at the index 208.

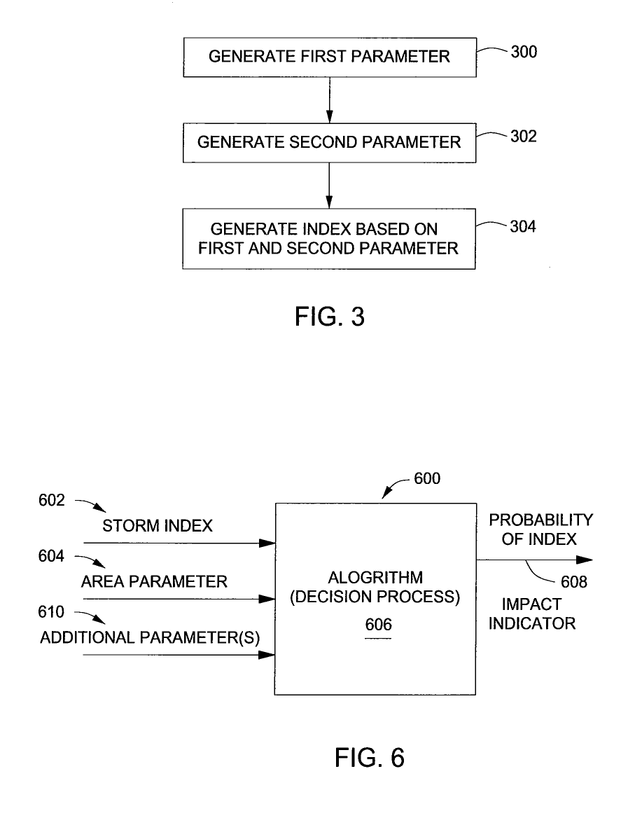

FIG. 3 is a flowchart depicting the present method for characterizing a tropical cyclone. The first step is generating the first parameter 202 shown at 300. The next step is generating the second parameter 204 shown at 302. In the next step shown at 304, the index 208 is generated based on the first and second parameters 202, 204.

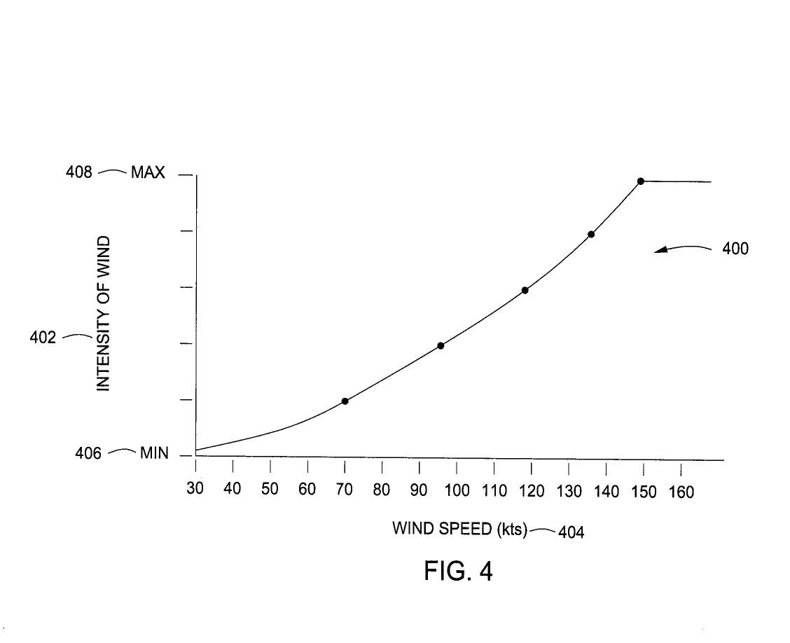

The first parameter 202 may be the intensity of the wind generated by the tropical cyclone. The maximum sustained wind is based on or a measure of the tropical cyclone's wind speed. For example, the intensity may be a measure of the tropical cyclone's wind speed equal to the average wind speed measured during a tine interval, for example 1 minute. Although the maximum sustained wind is described, it should be appreciated that the wind intensity may be any measure of the wind such as the maximum wind gusts, the wind speed at the Earth's surface, the wind speed at a certain elevation, the average wind speed through a certain range of elevations, etc. The force created by wind on an object or location is an exponential function of the wind speed. For example, doubling the wind speed in a storm will increase the force created by the wind on an object by four times. Thus, the wind intensity parameter should be weighted more heavily as the wind speed increases. FIG. 4 shows an example of a graph 400 which shows a wind intensity parameter 402 as the wind speed 404 increases. The wind intensity parameter 402 is shown as having a minimum value 406 and a maximum value 408. The maximum value may be 25 and the minimum value may be 0. The wind speed 404 is shown in knots on the graph 400. As shown, the wind intensity parameter 402 increases exponentially as the wind speed 404 increases. Thus, a low wind speed 404 will be given little or no value. The value of the wind intensity parameter 402 will increase slowly as the wind speed 404 increases initially. As the wind speed 404 increases, the wind intensity parameter 402 will increase more rapidly until the maximum value 408 is reached.

The wind intensity parameter 402 may be calculated using the following calculation method. The wind intensity parameter 402 is represented as the variable X. The wind speed 404 is represented as the variable V, and is in knots. If using miles per hour V=Vmph/1.151). If V is less than 30 knots X=0.1. If V is equal to or greater than 30 knots and less than or equal to 150 knots, X=[(V/30)ˆ2] rounded to the nearest integer. If V is greater than 150 knots X=25.

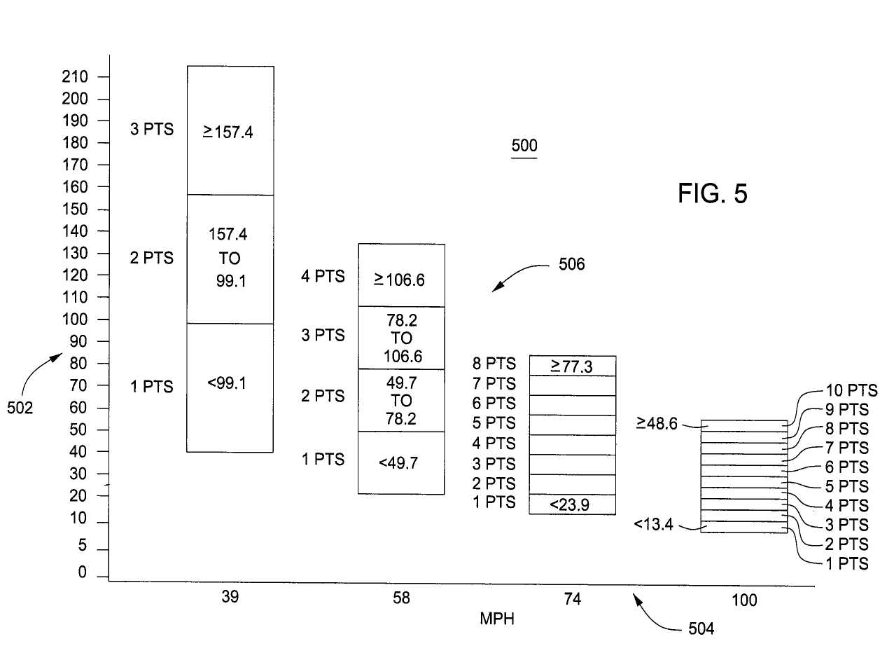

The second parameter 204 may be the size of the storm. The size of the storm is calculated by averaging the radii of certain wind fields generated by the tropical cyclone. The wind fields are broken into four general categories: 39 mph, 58 mph, 74 mph, and 100 mph. As stated above, the force created by wind is an exponential function of the wind speed. Thus, each of the four categories is weighted exponentially as will be described in more detail. FIG. 5 shows a chart 500 of a point scale for each of the four categories. A left side 502 of the chart 500 represents the miles of the radii of the wind field. The bottom 504 of the chart 500 lists each of the four categories: 39 mph, 58 mph, 74 mph, and 100 mph. An interior 506 of the chart 500 gives a point value for each of the four categories of wind fields. As shown, the number of points allocated for each wind field increases exponentially as the wind speed increases.

FIG. 5 shows the size parameter is calculated using the following calculation method. The radii of each of the wind fields are calculated in the unit of statute miles, in multiple directions. Because tropical cyclones may have different winds in different parts of the storm, information about the extent of winds into all four quadrants of the storm is combined to create a normalized radius (R). Each direction is assigned a variable for the equations below, as follows; northeast=NE, southeast=SE, southwest=SW, and northwest=NW. Then the radii (R) for each is calculated using the following equations: R39=0.5*(SQRT((R39NEˆ2+R39SEˆ2+R39SWˆ2+R39NWˆ2))), R58=0.5*(SQRT((R58NEˆ2+R58SEˆ2+R58SWˆ2+R58NWˆ2))), R74=0.5*(SQRT((R74NEˆ2+R74SEˆ2+R74SWˆ2+R74NWˆ2))), and R100=0.5*(SQRT((R100NEˆ2+R100SEˆ2+R100SWˆ2+R100NWˆ2))). The calculated values for R39, R58, R74 and R100 are utilized to determine how many of the possible size points that each wind threshold receives (S(R39), S(R58), S(R74), S(R100)). Summing these 4 values (S(R39), S(R58), S(R74), S(R100)) yields the total size points (S) earned by the tropical cyclone. The points may be allocated as follows:

If V is less than 39 mph (35 kts) then R39=0 so S(R39) then S=0.

If V is greater than or equal to 39 mph (35 kts) then if R39 is less than 99.1, then S(R39)=1, if R39 is equal to or greater than 99.1 and less than 157.4, then S(R39)=2, if R39 is equal to or greater than 157.4, then S(R39)=3

If V is greater than or equal to 58 mph (50 kts), then if R58 is less than 49.7, then S(R58)=1, if R58 is equal to or greater than 49.7 and less than 78.2, then S(R58)=2, if R58 is equal to or greater than 78.2 and less than 106.6, then S(R58)=3, if R58 is equal to or greater than 106.6, then S(R58)=4.

If V is greater than or equal to 74 mph (64 kts), then if R74 is less than 23.9, then S(R74)=1, if R74 is equal to or greater than 23.9 and less than 32.8, then S(R74)=2, if R74 is equal to or greater than 32.8 and less than 41.7, then S(R74)=3, if R74 is equal to or greater than 41.7 and less than 50.6, then S(R74)=4, if R74 is equal to or greater than 50.6 and less than 59.5, then S(R74)=5, if R74 is equal to or greater than 59.5 and less than 68.4, then S(R74)=6, if R74 is equal to or greater than 68.4 and less than 77.3, then S(R74)=7, if R74 equal to or greater than 77.3, then S(R74)=8.

If V is greater than or equal to 100 mph (87 kts), then if R100 is less than 13.4, then S(R100)=1, if R100 is equal to or greater than 13.4 and less than 17.8, then S(R100)=2, if R100 is equal to or greater than 17.8 and less than 22.2, then S(R100)=3, if R100 is equal to or greater than 22.2 and less than 26.6, then S(R100)=4, if R100 is equal to or greater than 26.6 and less than 31, then S(R100)=5, if R100 is equal to or greater than 31 and less than 35.4, then S(R100)=6, if R100 is equal to or greater than 35.4 and less than 39.8, then S(R100)=7, if R100 is equal to or greater than 39.8 and less than 44.2, then S(R100)=8, if R100 is equal to or greater than 44.2 and less than 48.6, then S(R100)=9, if R100 equal to or greater than 48.6, then S(R100)=10.

The total size parameter S is then calculated using the following equation: S=S(R(39))+S(R(58))+S(R(74))+S(R(100)).

The index 208 may be the sum of a first parameter 202 and a second parameter 204. The equation is as follows: Index=S+X. Thus, the index will range from a minimum of zero points to a maximum of 50 points for a large and very intense tropical cyclone.

It should be appreciated that an index may be created using only one of the above methods for calculating tropical cyclone size and wind speed. Further, other methods for calculating the size and the speed of the wind may be used and combined into one index.

Additional parameters 210 may be used in conjunction with any combination of the parameters above. The additional parameters 210 may include, but are not limited to, the following: minimum sea level pressure, flight level winds, whether winds/intensity are increasing/decreasing, speed of movement, rainfall potential, direction of movement, population at projected landfall, population at current location, potential for flooding at projected landfall/current location. Any combination of the parameter may be used in order to generate an index.

Storm Risk Indicator

A majority of organizations in cyclone prone areas have plans to ensure the safety of the personnel and property associated with the organization in the event of a cyclone impact. These plans typically have stages of storm preparedness. For example, a first stage may include identification of a potential threat from a cyclone, the next stage may be monitoring a significant disturbance and/or a cyclone, wherein a final stage may be complete evacuation of the personnel and securing of the equipment and/or property. The planning stages vary depending on the specific parameters of each organization. In many cases, to complete the stages and secure the property, equipment and personnel, it may take several days of work. Often by the time a weather forecast predicts impact with a location, or a city orders an evacuation, it is too late to safely secure the personnel, equipment and property of an organization. Further, there may be certain organizations having locations that are unmonitored by the news media, for example an offshore oil rig, a shipping lane, or a location of a ship. The first stage to effectively secure a location for an organization is identifying a potential cyclone risk.

FIG. 6 depicts a schematic view of a weather condition indicating method 600. As shown, the method 600 includes providing a storm index 602 and an area parameter 604 to an algorithm 606 or decision process. The algorithm 606 is then performed and the result of the algorithm 606 is a probability of impact 608, or risk indicator. The risk indicator may be used by an organization in order to execute a storm preparedness plan. Any number of additional parameters 610 may be included with the storm index and the area parameter 602, 604 in order to arrive at the probability of impact. The storm index parameter 602 may be any storm index.

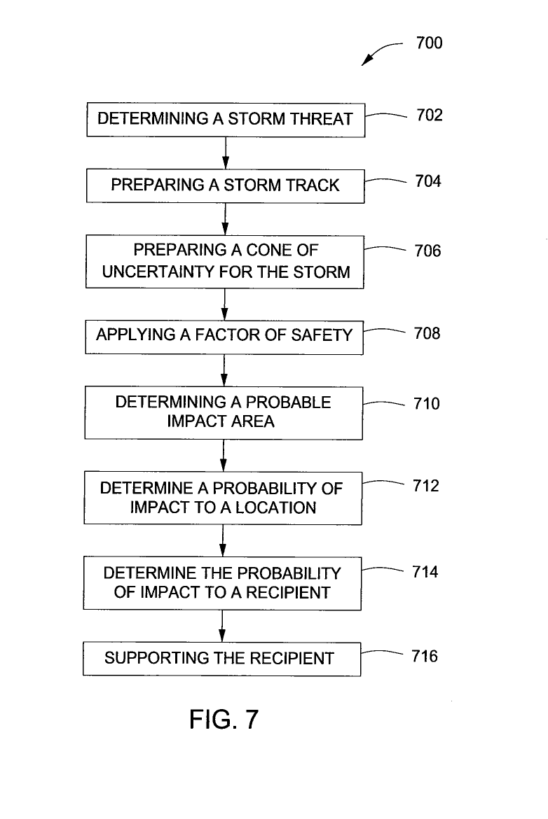

FIG. 7 is a flowchart depicting the weather condition indicating method 600. The first step is determining a storm threat 700. If there is not a threat of the storm developing into a significant disturbance or a cyclone, for example a tropical depression, tropical storm, or hurricane, then the next step are return to step 700. If the there is a probability that the significant disturbance will develop into a cyclone and/or hurricane, then the next step is preparing a storm track 704 for a period of time into the future. The next step is preparing a cone of uncertainty 706. The next step is applying a factor of safety 708 to the cone of uncertainty. The next step is determining a probable impact area 710. The next step is determining a probability of impact 712, for a location and/or a time in the future. In the next step, the probability of impact 712 is delivered to a recipient 714. In an optional final step, based on the probability of impact 714, the next step is further supporting the recipient 716.

FIG. 7 shows a method for determining a storm threat 700 is the first step. Weather conditions and storms are monitored every day. Most weather conditions, or weather systems, are of an inconsequential nature, that is, the weather system will not cause any damage to property, equipment or people. When a weather system poses the potential to become a significant disturbance, the weather system indicating method 600 begins. The significant disturbance may be any weather system that poses a threat of developing into a cyclone and producing damage to property and people. The significant disturbance may be any type of storm. In particular, the significant disturbance may be a tropical low, tropical wave, a frontal system, an upper level low, a tropical depression, or a tropical storm. If there is no potential for the weather system to develop into a cyclone, further monitoring of the weather system continues until the weather system threatens to become a cyclone or weakens further with no action being taken at that time.

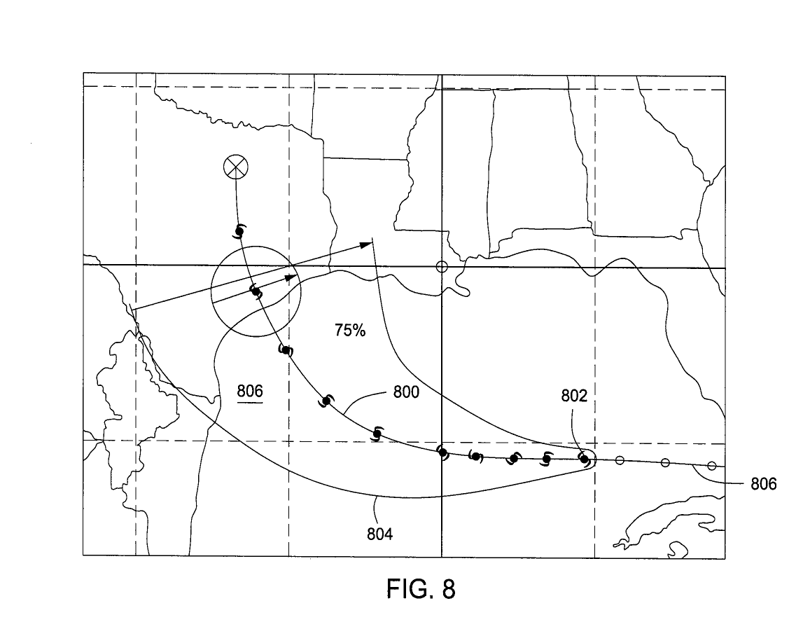

With the determination made that there is a potential for a cyclone, the next step is to preparing a storm track 704. A storm track 800, shown in FIG. 8, or path, may be determined for the storm including the point at which the disturbance, significant disturbance, tropical depression or tropical storm will develop into a cyclone, or a start point 802. The storm track 800 is a forecast that indicates the position of the storm center as a function of time from the forecast initialization. It should be appreciated that the storm track 800 may begin at any time before a cyclone develops. The storm track 800 is the forecasted track of the significant disturbance or cyclone for a time period in the future. The storm track 800 indicates the direction the storm is expected to travel over a time period in the future. The track 800 may be placed on a map which includes the geographic location of the storm based on longitude and latitude, and the predicted location in the future based on longitude and latitude. The period of time in the future may be any time period, for example 7 days in the future. Further, the track 800 may predict the storm track for as little as 1 minute into the future or as much as 30 days into the future. More particularly, the track 800 may predict the storm track for as little as 6 hours into the future or as much as 10 days into the future. Although shown on a map, the track 800 may be compiled in any form including, but not limited, to a log, a graph, a map, chart, or a table.

The next step is preparing a cone of uncertainty 804. The cone of uncertainty 804 may begin at the start point 802, where the significant disturbance, tropical depression or tropical storm is projected to reach cyclone, or hurricane intensity. Further, the cone of uncertainty 804 may begin at any location. The cone of uncertainty 804 represents geographic locations, in the future, that the storm is most likely to impact along the track 800. The storm becomes more unpredictable the further in the future the track 800 is from its current location; therefore, the cone of uncertainty 804 becomes larger the further in the future. The graphical location of the cone of uncertainty 804 is defined by arrays of latitude and longitude points for the movement of the storm for the time in the future. The cone of uncertainty 804 is a rough prediction of the area the storm may impact.

An area 806 of the cone of uncertainty 804 may be determined using a number of criteria. For example, the area 806 of the cone of uncertainty 804 may be based on statistical data for storms in the past. The statistical data may be based on storms for any number of years in the past. For example the data may be based on storms from the past 5 years. Other factors that may influence the cone of uncertainty 804 may include, but are not limited to, the current intensity of the storm, the speed of travel of the storm, the extent of the storm organization, the track history of the storm, the convergence or divergence of guidance from numerical weather models, and environmental conditions in the path of the storm. One or a combination of these factors may be used to determine the area 806 that the storm may impact which is the cone of uncertainty 804. The cone of uncertainty 804 may have a width that has an equal distance on both sides of the track 800. Further, based on past trends and statistical data the cone of uncertainty 804 may be skewed to one side of the track 800. That is, more of the width of the cone of uncertainty 804 may be on one side of the track 800 than the other.

With the cone of uncertainty 804 determined, it may be desired to apply a factor of safety to the cone of uncertainty. The confidence that a forecaster has in the track 800 of a storm depends on a number of variables. Some storms are very predictable, while other storms are extremely unpredictable. The cone of uncertainty 804 may be changed by a factor of safety which depends on the forecast confidence. That is, the width of the cone of uncertainty 804 may be increased or decreased in size depending on the confidence level in the present forecast. For example, if there is a high level of confidence in the forecast track the width of the cone of uncertainty 804 may be reduced by a high percentage, for example 40%. If there is an above average level of confidence in the forecast track, the width of the cone of uncertainty may be reduced by a slightly lower percentage, for example 20%. If there is an average level of confidence in the forecast track, the width of the cone of uncertainty 804 may retain its initial configuration. If there is a below average level of confidence in the forecast track, the width of the cone of uncertainty 804 may be increased by a slightly higher percentage, for example 20%. If there is a low level of confidence in the forecast track, the width of the cone of uncertainty 804 may be increased by a high percentage, for example 40%. Although five confidence levels are described, it should be appreciated that any number of confidence levels may be used to graduate the cone of uncertainty 804 based on confidence in the forecast. All of the figures may be modified for any particular storm and conditions surrounding the storm. Further, the factor of safety may be increased and/or decreased as the period of time increases in the future. For example, the factor of safety over the next 24 hours may be low, while the factor of safety for a time greater than 24 hours may be gradually greater. Further, the factor of safety is optional.

With the factor of safety applied, the cone of uncertainty 804 represents the probable area that the storm will impact for a time in the future. The points located near the track 800 represent the area that has the highest probability of being impacted by the storm. The areas located near the edge of the cone of uncertainty 804 represent the areas having some risk of being impacted; however, the risk is lower.

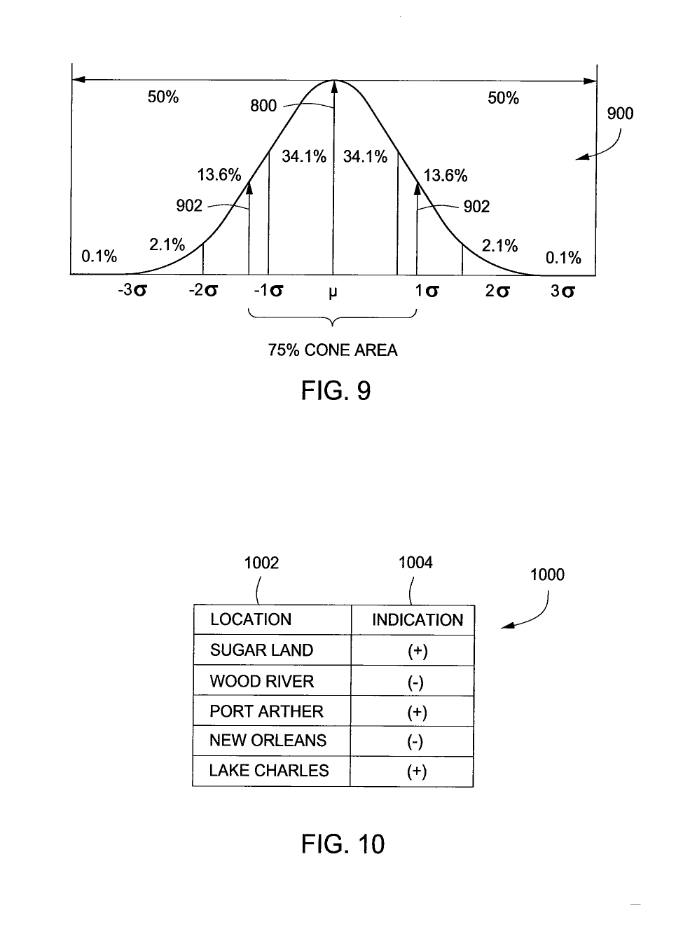

The probable impact area may now be determined for the storm. The probability of impact within the cone of uncertainty is a distributed probability. For example, the probability may follow a Gaussian distribution 900, or normal distribution. In a Gaussian distribution, the probability of impact sharply decreases as the distance from the storm track is increased. FIG. 9 shows a typical Gaussian distribution wherein the mean of the distribution μ represents the storm track 800. The 37.5% of probability to each side of the mean μ is represented by the arrows 902. Thus, the area of the distribution between the arrows 902 represents 75% of the probability of impact. This 75% area may be used as the probable impact area for that particular storm. The probable impact area may be increased or decreased depending on the type of storm and/or the needs of any clients within the cone of uncertainty. The probable impact area may include the area where 90% of the strong winds from the storm are forecast. The area will extend a distance from the center of the storm in all directions and will depend on the type and formation of the storm and the atmospheric and geographical conditions surrounding the storm. Although shown as a Gaussian distribution, it should be appreciated that the probable impact area may be skewed to one side or the other of the mean μ depending on the storm, atmospheric conditions and geographical conditions. In this case, the probable impact area would be skewed with as well. Thus, there would be a greater risk of impact on one side of the storm track that on the other side of the storm track.

The probable impact area is then applied to a geographical area, for example on a map, chart, or table. The probability is displayed on a map. The map may include the probability of impact with a numerical indicator of the time in the future for the areas affected. The probability of impact may then be conveyed to a recipient in order for the recipient to implement plans for property and personnel.

The weather condition indicating method 600 may be performed for a predetermined recipient or client. The recipient provides locations, or action locations, that are critical to the operations of the recipient. The action locations are monitored at all times with respect to the probable impact area of any cyclone, or hurricane. Thus, once the probable impact area of the cyclone is determined as described above, all of the action locations that are within the area of impact will be identified. The recipient will then receive an indicator stating which of their action locations are within the probable impact area and may receive an indicator of the action location which are not within the probable impact area. If the action location is not within the probable impact area, the recipient may continue operations as normal. If there is a positive indication that the action area is within the probable impact area at any time in the future, the recipient will be notified of the risk. In one example, a simple positive (+) or negative (−) indicator is sent directly to the recipient or client. The indicator may include a map including the projected time at which the storm may impact the location.

FIG. 10 represents a chart 1000 that may optionally sent to a recipient for the weather condition indicating method. The chart includes hypothetical action locations 1002 the recipient has provided where that recipient's operations occur. The next column is the indicator column 1004. The indicator column, as shown, is simply a positive or negative indication that the location is within the probability of impact area. The recipient, upon receiving the indicator, may then begin plans in order to secure the location against the cyclone risk. The simple positive and negative indicator gives the recipient a straightforward indication of risk. The recipient knows right away that with a negative indicator there may be no need to take immediate action. The recipient knows that the positive indicator shows that action may need to be taken to prepare for the possible cyclone.

Although the table 1000 is shown as only including a positive and negative indicator, it should be appreciated that the positive indicator may be statistically weighted. That is, the positive indicator may include a number that corresponds with the percent chance of impact, as described above. Further, the percent chance of impact may include an indication of the change from the last time the recipient viewed the indicator. Although shown as a table 1000, it should be appreciated that any method may be provided to convey the indicator.

The recipient may receive the indicators in any medium. For example, the indicator may be sent to the client by any of the following mediums including, but not limited to, via email, phone, pod-cast, fax, mail, television, websites. In one example, a personal web page or website is set up for the recipient. The web page may graphically depict the area impacted by the possible cyclone and include the indicators for each of the recipient's action locations. The web page may optionally be password-protected for the specific client.

The result of a positive indicator to a recipient may prompt more support. That is, the client may request that with a positive indicator, that each of the action locations be monitored more closely and that more tools described herein be provided to the recipient.

Probability of Wind Impact

Storms such as tropical cyclones vary in size and intensity. A hurricane and/or tropical cyclone, for example, may have winds over 150 mph near the center of the storm while the winds near its outer bands are much lower. A significant portion of the damage caused by a tropical cyclone is caused by its high winds. The damage caused by the tropical cyclone is proportional to the speed, or velocity, of the wind that impacts the location, among other factors. Therefore, a forecast that the tropical cyclone may strike a location is not a comprehensive view of the potential for the impacts and damage the tropical cyclone may cause at that location. A detailed method of indicating a weather condition may be provided to the recipient. Further, the weather condition may include providing a probability of a wind field impacting a location for a period of time in the future.

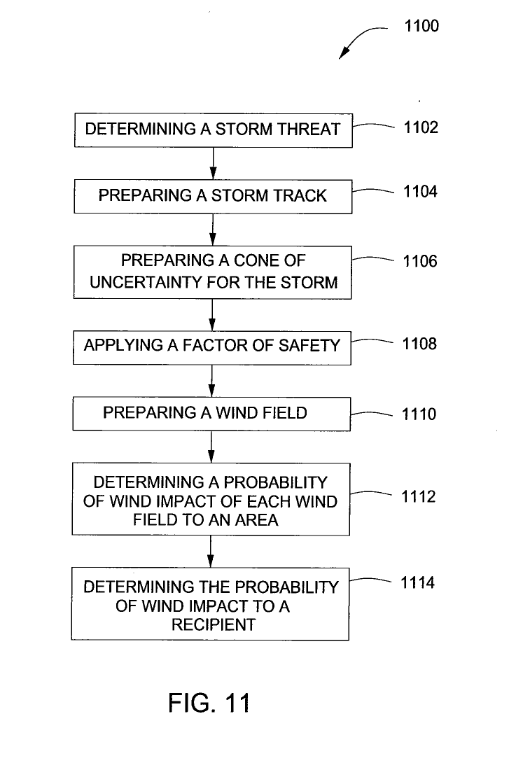

FIG. 11 shows a flowchart depicting a method for creating and/or delivering a probability of wind impact to a recipient 1100. The first step is determining a tropical cyclone threat exist 1102. If there is not currently a threat of a significant disturbance developing into a tropical cyclone, for example a tropical depression, tropical storm, or hurricane, then the next step is return to step 1102 and reassess the disturbance at a later time. If the significant disturbance has a probability of developing into a tropical cyclone, then the next step is preparing a storm track 1104 for a time into the future. The next step is preparing a cone of uncertainty 1106 for the storm. The next step is applying a factor of safety 1108 to the cone of uncertainty. The next step is preparing a wind field 1110. The following step is determining a probability of wind impact of each wind field to an area 1112. In the next step, the probable wind impact is delivered to a recipient 1114. In an optional final step, not shown, further support is provided to the recipient.

With the determination made that there is a potential for a tropical cyclone, the next step is to prepare a storm track 1104. The storm track may be determined by any of the methods described above, including the same manner as is shown in FIG. 8. The storm track 800 is a forecast that indicates the position of the storm center as a function of time from the forecast initialization. The time in the future may be any time period, for example 7 days in the future. Further, the storm track may predict the storm track for as little as 1 hour into the future or as much as 30 days into the future. More particularly, the storm track predicts 7-10 days into the future. Although shown on a map in FIG. 8, the storm track may be compiled in any form, including but not limited to a log, a graph, a map, or a table.

The cone of uncertainty may be determined by any of the methods described above, including the same manner as is shown in FIG. 8. A Gaussian 75% cone of uncertainty may be used, as described above. The cone of uncertainty may be derived from a mean storm track error and may be calibrated by a factor of safety, as described above. The factor of safety applied to the cone of uncertainty may be accomplished in the same manner as described above.

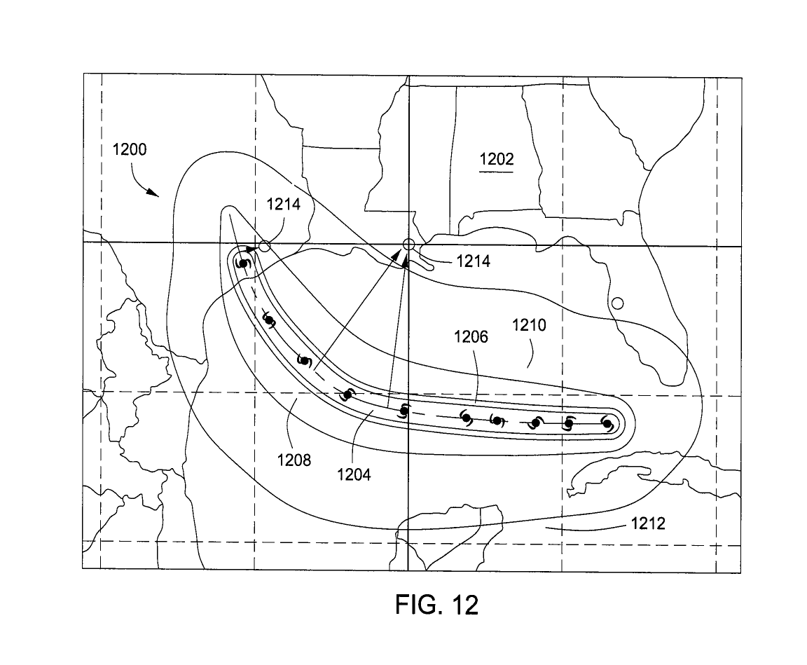

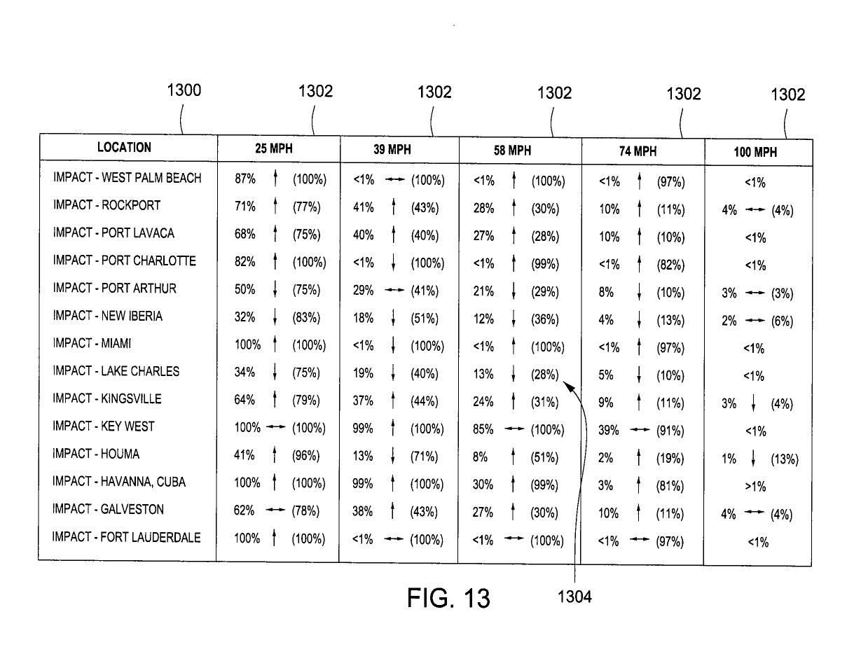

With the cone of uncertainty and the factor of safety applied, the wind field of the storm for an area in the future may be calculated. This wind field is a forecasted wind field. The forecasted wind field is a probability of one or more wind zones affecting a particular location. Each of the wind zones represents a range of wind speeds. For example, one wind zone may include all wind speeds over 74 mph, while a second may include all wind speeds below 74 mph. Any number of wind zones may be added and any breakdown of wind speed may be used. FIG. 12 depicts a wind field 1200 placed on a map 1202 having 5 wind zones. For exemplary purposes, 5 wind zones will be described herein, zone A 1204, zone B 1206, zone C 1208, zone D 1210, and zone E 1212, are shown in FIG. 12. Zone A 1204 will represent the strongest intensity portion of the storm, typically proximate the center of the storm. Zone E 1212 will represent the weakest intensity portion of the storm, typically near the outer reaches, or bands, of the storm. Zones B-D descend in intensity away from the center of the storm. Zone A may represent the winds greater than or equal to 100 mph, zone B represents the winds greater than or equal to 74 mph and less than 100 mph, zone C represents the winds greater than or equal to 58 mph and less than 74 mph, zone D represents the winds greater than or equal to 39 mph and less than 58 mph, Zone E represents the wind intensity for winds less than 39 mph. It should be appreciated that the there may be any number of zones and that the wind speed in each zone may vary depending on the needs for a particular recipient. The wind field 1200 depicts a graphical display that allows a recipient to view which wind zone is likely to affect the recipient's location(s). The wind field 1200 may further or alternatively be displayed in a table 1300 as shown in FIG. 13. The table may include an action location 1300, and any wind zones calculated. For each of the action locations a probability of wind impact from each zone may be provided, as will be described in more detail below.

The wind field described in conjunction with FIGS. 12 and 13 depicts the wind field 1200 may be calculated as a function of the following factors including, but not limited to, geographic direction from the storm center, current and/or predicted intensity and/or size of the tropical cyclone, speed of forward movement, elapsed time relative to initialization of the forecast, extent of the tropical cyclone organization, convergence or divergence of guidance from numerical weather models, and environmental conditions in the path of the tropical cyclone.

The next step in the analysis is determining the probability of impact of the wind zones on one or more action locations 1214 of a recipient. The probability of wind impact may be accomplished by any statistical calculations to provide the recipient with the information that a particular action location will be affected by one or more of the wind zones.

The probability of wind impact for a particular action location 1214 may be calculated for each action location. For exemplary purposes, the probability of wind impact for one action location will be described. With the wind field calculated, the cross-path diameter, or radius, of each of the wind zones may be calculated using simple trigonometry. In one example, the radius of zone A is 30 miles. The storm track would need to pass the action location within 30 miles to the left or right of the action location to receive zone A winds. However, the probability that the storm moves outside the storm track within or outside the cone of uncertainty mat need to be factored into the probability of zone A winds impacting the action location. Thus, in one example, if the action location were located 50 miles to the left of the storm track, an integration of the (Gaussian) probability density function of the cone of uncertainty between 80 miles to the left of the storm track (which represents 30 miles to the left of the action location) and 20 miles to the right of the storm track (which represents 30 miles to the right of the action location) would yield the probability of that location being impacted by the zone A winds. This same approach may be taken for each of the zones to obtain a probability of each of the wind zones impacting the action location.

One specific method of calculating the probability of each zone impacting the action location is as follows. The first step is to find the distance X from the storm track to the action location. The distance X is the distance along the perpendicular path from the storm track to the action location, as shown in FIG. 12. If the action location is to the left of the storm track the distance X is given a negative (−) value, if the action location is to the right of the storm track the distance X is given a positive (+) value, if the action location is on the storm track, it is given a 0 value. Note the distance X is calculated from the closest approach between the action location and the storm track.

After determining the distance X to the action location 1214, the probability of each zone impacting the action location may be calculated. In one example, the probability or standard deviation is σ. The standard deviation σ, in one example, may assume that 12.5% (for a 75% cone of uncertainty) lies to the left and the right side of the cone of uncertainty. In one example, if the action location is to the left of the storm track, σ=X/−c. For the 75% cone of uncertainty constant c=1.15. Thus, if X=−100, then σ=86.96. For the 75% cone of uncertainty the distance from the storm track to the outer edge of the cone is 100 miles at 24 hours in the future if the factor of safety is zero. Note, that if the % of the cone of uncertainty changes the constant changes, for example c=1.64 for a 90% cone of uncertainty. It should be appreciated that the probability of wind impact may be computed for action locations both within and outside of the cone of uncertainty with a known σ value and knowledge of the probability density function.

Most storms or cyclones are not symmetrical about the center of the storm. That is, most cyclone wind fields extend out a greater distance on one side than on the other side. Therefore, it may be necessary to factor in the distance of the storm deviation Y, or storm hangover. In one example, the cyclone is broken up into 4 quadrants, a northeast NE, northwest NW, southwest SW and southeast SE quadrant. These quadrants are predicted radii for different wind thresholds at different forecast times. The distance between the cyclone's wind zone and the action location is affected by the storm deviation Y. Therefore, it may be beneficial to calculate a modified distance X′. In one example, the modified distance X′ is calculated as follows X′=X+Y(right of the track) and X′=X+Y(left of the track). Thus, if the zone has a YSE=YNE=30 miles, and YNW=YNW=15 for a storm track with a Northward heading, then the Y (right)=30 and Y(left)=15. Therefore, in order for the zone's winds to impact the action location, the storm must pass within a distance of X between 30 miles to the left and 15 miles to the right of the action location. In the case of the action location having a distance of X=−70, X′=X−Y(right), and X′=X+Y(left), thus X′=−70−30=−100 and X′=−70+15=−55. The probability of impact may then be calculated by integrating the following probability density function from X′ to Y′: f(x)=[1/(σ)(sqrt(2π))]*expˆ[−(X′ˆ2)/(2(σˆ2)]. f(x) may represent the equation for a Gaussian probability density function. This calculation may be repeated for each action location and each wind zone to provide the recipient with a probability of wind impact for each wind zone at each action location.

The following calculation provides an alternative or additional probability of wind impact calculation. A maximum theoretical wind speed and/or sustained wind speed for the action location may be calculated as follows. This alternative method allows for the calculation of possible wind zones impacting an action location even when the action location lies outside of the forecasted wind zone. The maximum theoretical wind speed is approximately the 90^{th} percentile of all possible wind intensities for the action location. The maximum probability of wind impact f(x)′ accounts for the winds that lie between the wind zone forecasted and the upper probability of the wind zone occurring for a time in the future.

The first step in calculating f(x)′ may be calculating f(x), as described above, for each zone and action location using the method described above. If the action location is within the zone for the wind field, then f(x) is the probability of wind impact of that wind zone at the action location. If the action location is beyond the zone but still within the maximum possible wind zone, then the maximum probability f(x)′ needs to be calculated. If the action location is beyond the maximum of the wind zones, then the probability of impact from the particular zone is f(x)=0 for the action location.

The maximum probability f(x)′ will be illustrated by an example. If the upper wind speed Wm is 80 mph, Wm=80, and the forecasted wind speed Wf is 55 mph, then zone D, the zone having a radii including wind speeds from 58 mph and those of 74 mph may need to be adjusted, while the 39 mph wind zone probability of wind impact may be calculated from f(x) above and does not need adjustment. The zone D radii may need to be added based on the average relationship between the explicitly forecasted 39 mph radii Rex39 of zone D and the estimated calculated 58 mph radii Rex58 of Zone C. Further, the zone B wind radii for Rex74 may need to be added based on the average relationship between the explicitly forecasted mph radii Rex39 of zone D and the estimated 74 mph radii Rex 74 of zone B and then the radii may need to add the explicitly calculated 74 mph radii Rex74 based on the average between the explicitly predicted 39 mph Rex39 and estimated 74 mph radii Res74.

In another example, the upper wind speed is 120, Wm=120, and the forecasted wind speed Wf is 105. In this case, when using the five zone method described above, no extra wind radii needs to be calculated because Wf is within zone A and there are no zone thresholds Wf and Wm.

Within cyclones, radii with higher wind speeds are typically smaller and more tightly contained around the center of the storm than wind radii with lower wind speeds. In order to calculate the estimated radii Res for the highest wind field that is forecasted, an approximate radii constant Cr may be multiplied times the explicitly calculated Rex. Therefore, Res=(Cr)(Rex).

In one example the following approximate radii constants are used:

| | When the maximum wind | Multiply the fore- |
|---|---|---|
| To estimate a | radii explicitly | casted radii by |
| wind radii of: | forecasted is: | the following Cr |
| Res of 100 mph | 74 mph | 0.51 |
| Res of 100 mph | 58 mph | 0.32 |
| Res of 100 mph | 39 mph | 0.19 |
| Res of 74 mph | 58 mph | 0.55 |
| Res of 74 mph | 39 mph | 0.30 |
| Res of 58 mph | 39 mph | 0.50 |

It should be appreciated that the constant Cr may be adjusted depending on a particular recipient's needs, or research into typical cyclone wind field radii.

Continuing with the example mentioned above, if the maximum probability of a 58 mph zone wind field impacting an action location is M58=20% and the maximum probability of a 74 mph zone wind field impacting the same action location is M74=10%, then the M58 and M74 may need to be adjusted downward. The downward adjustment may be desired because the maximum probabilities assume that the wind speed forecasted at the hour closest to the action location is actually at 80 mph. Thus, the M74 may need to be adjusted downward and the M58 may need to be adjusted downward to a lesser degree because it is closer to the forecasted wind speed value. To make the downward adjustment, you may find the maximum probability standard deviation σ′. The standard deviation σ′ for this example will be based on a 90^{th} percentile Gaussian distribution; this may be adjusted depending on the needs of the recipient. Note, the maximum wind speed Wm should be valid for the interpolated time (t) closest to the action location. The difference in the wind speed is Wd(t)=Wm(t)−Wf(t). Thus, for the particular time (t) the standard deviation σ′=Wm(t)/1.28. If the maximum wind speed at time (t) is Wm(t)=80 mph and the forecasted wind speed at time (t) is Wf(t)=55 mph, then the difference in wind speed is Wd(t)=80−55=25. Then the standard deviation σ′=25/1.28=19.53. The maximum adjusted probability may now be calculated for the maximum predicted wind field. The maximum probability PM=[1/(σ′)(sqrt(2π))]*expˆ[−((X′−Wf)ˆ2)/(2(σ′ˆ2)]. Thus, to obtain the maximum probability PM of the wind impact above the highest forecasted wind zone, the standard deviation σ′ is plugged into the probability equation. Further, the forecasted wind speed Wf at the time (t) in question is used. These values are integrated to distance X between the upper limit of the highest zone and infinity for a maximum probability f(x)′.

Any of the probability of wind impact calculations above may incorporate a factor of safety and/or adjust the probability based on factors including, but not limited to, asymmetry of wind zone radii, land-friction and terrain effects on the storm, and the length of forecast time.

The examples of the calculations above are for exemplary purposes only. It should be appreciated that the equations and method to derive the probability of wind impact may be modified based on a particular recipient's needs.

With the probability of wind impact determined for each wind field zone and each action location, the probability may be compiled in a deliverable form that is easy for a recipient to use. The deliverable may then be received by the recipient. FIG. 13 shows the probability of wind impact is presented as a table 1300. The table includes a first column 1300. The first column 1300 may represent the action location(s). Further, the table includes probability columns 1302 that represent the probability of wind impact within each of any number of the wind field zones. The probability may represent the upper or lower probability of wind within that particular zone impacting the action location. For exemplary purposes, the probability of the lower limit of the wind speed for each of the zones will be described in conjunction with the table 1300. Thus, if the columns represent the zones A-E as described above, the zone A column 1302 represents the probability of 100 mph winds impacting the action location and zone E represents the probability of 25 mph winds impacting the action location. For each action location each column includes three indicators. The first indicator shown is the probability of wind impact, which is that specific location's probability of receiving that threshold of wind speed within the forecast period from the cyclone. The second indicator shown is an arrow that indicates whether the first indicator has increased ↑, decreased ↓, or has not changed [symbol] since the last updated probability computations associated with the previous forecast package. The third indicator is the maximum theoretical probability for the point along the forecast track that is closest to the action location. If the action location was directly in the forecasted path of the cyclone, then this maximum theoretical probability given and the first indicator would be equal. For example, three indicators 1304, in the 58 mph column, includes the values 13% ↓ (28%). These three indicators 1304 represent that that location has a 13% chance out of a possible 28% chance of receiving 58 mph winds from the latest forecast. This 13% value has decreased since the previous forecast issued and therefore the threat for this location for this wind field has diminished. The third indicator is shown in parenthesis to distinguish it from the first indicator; however, any representation may be made. Thus, the table may be viewed quickly by a recipient, allowing the recipient to obtain the probability of multiple wind fields impacting multiple action locations in the future. This tool provides an invaluable service to help the recipient plan a course of action for personnel, property and equipment at each of the action locations. Although shown as a table 1300, it should be appreciated that any method may be provided to convey the probability of wind impact to the recipient.

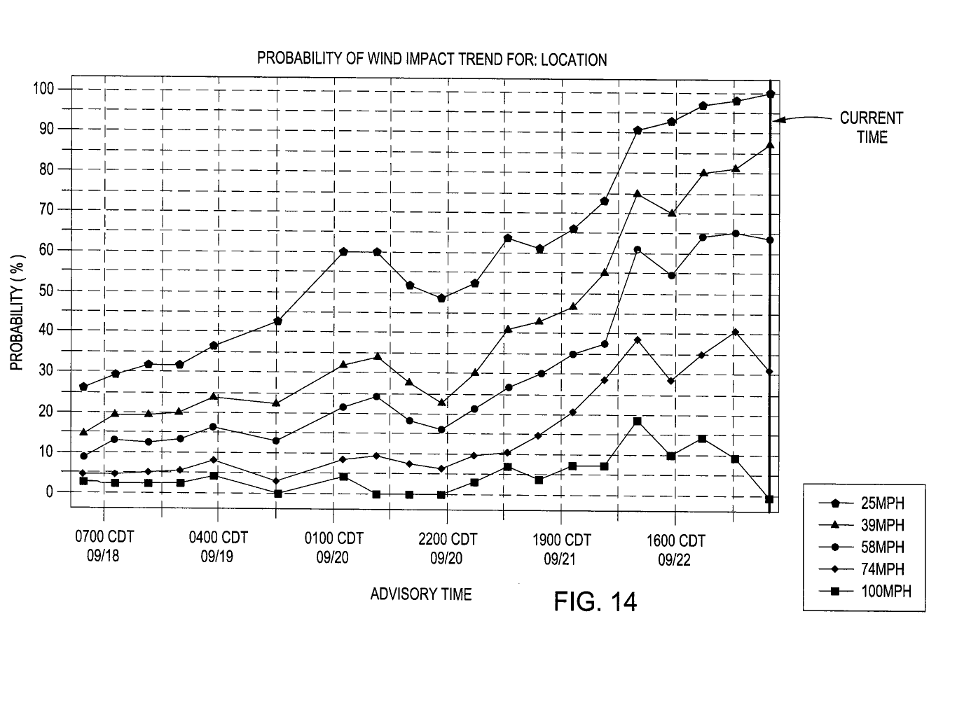

FIG. 14 shows a chart 1410. The chart 1410 may depict the probability of wind impact for multiple wind fields as they evolve over a period of time. Each of the one or more lines 1412 represents a separate probability of wind impact for a wind field. In the example shown, as time advances along the bottom axis X the probability increases from 0% to 100% along the Y axis. It should be appreciated that the lines 1412 may have any configuration depending on the cyclone that is represented in the chart 1410. The chart may be delivered to the recipient by any of the methods described in this application. Further, the chart 1410 gives the recipient a quick easily understandable graphical depiction of a cyclone for a location.

The recipient may receive the probability of wind impact in any medium. For example, the probability of wind impact may be sent to the client by any of the following including, but not limited to, via email, phone, pod-cast, mp3, fax, mail, television, web page websites. In one example, a personal web page or cite is set up for the recipient. The web page may graphically depict the area impacted by the storm and include the indicators for each of the recipient's action locations. The web page may optionally be password protected for the specific client. Further, any of the methods described herein may be received by the recipient separately or in conjunction with the probability of wind impact.

A high probability of wind impact at the recipient's action location may trigger a request for more support from the recipient. That is, the client may request that with a high probability of high winds, that each of the action locations be monitored more closely and that more tools described herein be provided to the recipient.

Worst Case Scenario

A majority of organizations in storm prone areas have plans to ensure the safety of the personnel and property associated with the organization in the event of a storm impact as discussed above. However, the action taken by the organization or recipient may depend on the forecast strength of the cyclone to impact the recipient's action location(s). Cyclones have a wide variety of maximum winds, and/or sustained winds and size. For example, there may be a very high probability that a storm will impact the recipient's action location(s); however, the probability of impact by the cyclone's strongest winds may be much lower. It is beneficial for the recipient to know the worst case scenario that may impact all action location(s). Even though a specific location may not currently be in the projected path of a storm, it is possible that the track of the storm may shift over a period of time and impact that location. Further, observed maximum sustained winds may vary from the projected maximum sustained winds. A storm may strengthen or weaken more than initially forecast or move in a direction not forecast. The organizations that rely on the weather predictions described herein need to assess their risk and implement plans based on those risks. Thus, the recipient will be given a worst case scenario for a particular storm, cyclone, or storms. The worst case scenario may include a minimum time, or earliest time, before certain thresholds of winds from a particular cyclones' wind field may impact their action location and the maximum wind speeds, sustained winds and/or wind gusts, which may impact the action location. Knowing the worst possible scenario that may impact any of an organization's locations is a beneficial tool in the decision making process.

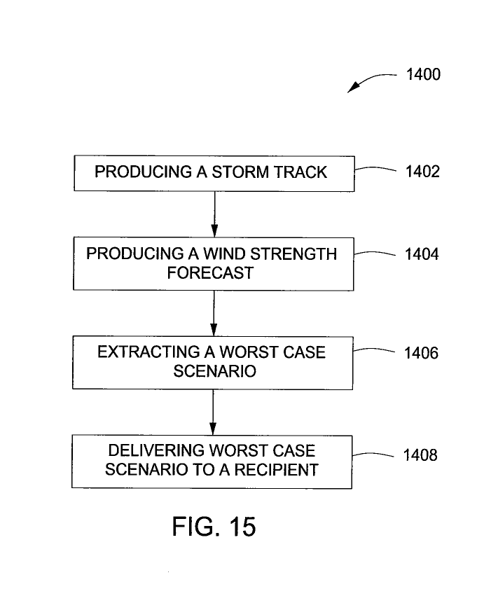

FIG. 15 depicts a method 1400 of delivering a worst case scenario to a recipient. The method begins with producing a storm track 1402. The next step is producing a wind strength forecast 1404. The next step is extracting a worst case scenario 1406 from the wind strength forecast and the wind field forecasts for the location. The next step is delivering the worst case scenario to the recipient 1408. Optionally, additional support, not shown, may follow step 1408.

Determining the storm threat to the location is done in the same manner as described above. The worst case scenario may be provided whether or not the action location is forecasted to fall within any of the wind fields of the cyclone. Even if a cyclone is several thousand miles away from an action location, a worst case scenario may be extracted for that location to show how much time there is before a possible impact. The step of producing a wind field, or strength, forecast is performed in the same manner as described above. The wind field forecast may include the projected size of the wind radii for different wind thresholds and the maximum sustained wind speed for the storm at different points along the forecast track. The wind fields for the storm are produced. The wind fields, or zones, may indicate a radial distance from the storm center of each specific wind speed component at various times along the track. The wind field, or strength, forecast may be a function of any combination of the following factors including, but not limited to, the geographic direction from the storm center, current intensity of the storm, current wind field of the storm, past wind field of the storm, speed of forward movement of the storm, elapsed time relative to initialization of the forecast, extent of storm organization, convergence or divergence of guidance from numerical weather models, and environmental conditions in the path of the storm. Therefore, the forecasted maximum wind field size and maximum wind may be readily ascertainable from the wind field, or strength forecast.

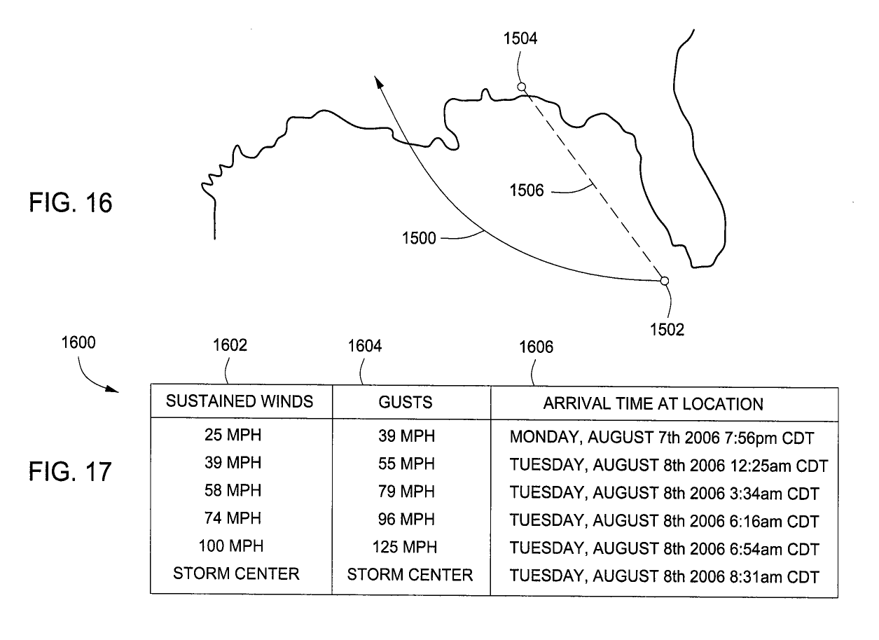

A storm track 1500, shown in FIG. 16, may be produced in the same manner as described above. The storm track 1500 may indicate the forecasted position of the storm center 1502 as a function of time from the forecast initialization. The storm track 1500 may include the projected path and optionally the time at which the storm arrives at various locations on the storm track 1500.

The next step is extracting a worst case scenario 1406, for the storm. As discussed above, any recipient may have one or more action locations 1504, one shown. The recipient may need to know the storm situation at each of the action location(s) 1504. The worst case scenario may provide the recipient with a scenario that is worse than the actual threat the storm poses. Thus, the recipient may receive an estimated impact time that is shorter than the actual impact time. This allows the recipient to prepare for the worst case time schedule. Preparing for the worst case time schedule ensures that the action location is ready for the storm before the storm arrives. Further, the recipient may receive an estimated wind field impact that is worse than the actual threat the storm poses. This allows the recipient to prepare for the worst wind possible. These methods may be combined to provide a worst case time and wind estimate, or they may be used separately.

The worst case time estimate may be determined by using the fastest travel time of the storm in conjunction with a straight line distance 1506 from the current storm center to the action location 1504. The fastest forecasted travel speed is known from the storm track 1500 or it may be explicitly predicted separately from the storm track. The straight line distance 1506 from the storm center 1502 to the action location may be determined using map scales, simple trigonometry, GPS, great-circle calculations for distance between two points on the Earth's surface, or any other known method of calculating distances. The worst case time estimate assumes that the storm travels along the straight line distance 1506 at the fastest forecasted travel speed for the entire distance. Thus, the time estimate may simply be the straight line distance 1506 divided by the speed. Because it is improbable that any storm travels at its maximum forecasted travel speed, and in a straight line, the time estimate for impact at the action location 1504 is conservative.

A factor of safety may be included to increase or decrease the worst case time estimate depending on each action location 1504 and specific needs of the recipient. For example, the travel speed used may only be a percentage of the maximum travel speed such as 90% or 110%.

The worst case time estimate may be modified by incorporating the fastest theoretical travel speed of the cyclone. That is, the travel speed used is based not on the highest forecast speed but the highest possible speed a storm of this nature may travel.

The worst case time estimate may further be modified by incorporating the largest possible cyclone. That is, the worst case impact time at the action location may be based on an increased size estimate for the storm. Increasing the size of the storm may cause the wind field to arrive sooner at the action location(s) than it would otherwise. The impact time may be the time when the outer bands of the cyclone impact the action location 1504. It may be estimated that the maximum strength of the cyclone is in the outer bands, or there may be a graduated wind field as described herein.

The worst case scenario for the wind intensity may also be provided to the recipient. This allows the recipient to prepare for the worst wind damage from the storm. Therefore, any preparations made by the recipient for the worst case scenario wind intensity will be conservative in nature, thereby ensure minimal damage at the action location.

The worst case scenario for the wind speed may be based on the largest forecasted wind field or wind radii of different wind thresholds. The largest forecasted wind field for any point along the forecast track may be projected to impact the recipient's action location(s). The largest forecasted wind radii for a particular wind speed threshold may include the maximum value of that wind radii's four quadrants to be used for all quadrants in the storm. It may also be assumed that the cyclone reaches the action location(s) at the highest maximum winds, sustained or gusts, projected along the track. It is unlikely that a cyclone impacts an action location(s) at the maximum forecasted size and intensity, therefore the largest forecasted storm is a conservative estimate.

The largest forecasted storm may include no wind field zones and simply be the maximum forecasted intensity distributed over the maximum size of the storm to provide the largest forecasted storm. Historically average values for various wind speed radii thresholds for different intensity storms may also be used instead of explicitly forecasted wind field zones.

Further, the worst case scenario may be estimated for rainfall potential or flooding potential associated with the storm, at the action location. The flooding estimate for the action location may be calculated using the maximum predicted rainfall for the storm as falling on the action location. The rainfall amount may be predicted for the entire time the storm is forecasted to impact the action location and/or the longest possible time the storm may impact the action location. Further, the worst case flood estimate may incorporate any storm surge estimate, or levee breaches.

Any of the methods of determining the worst case scenario may be combined. Further, the methods for predicting the worst case scenario may include a factor of safety in order to make the worst case have a greater or lower impact on the action location depending on the requirements of the recipient.

FIG. 17 depicts a table 1600 that may show the worst case scenario to the recipient in a deliverable form. The table 1600 includes a first column 1602 which represents the sustained winds of the storm. The table 1600 may further include a second column 1604 which represents the wind gusts of the storm. The table 1600 may further include a third column 1606 which represents the earliest possible arrival time of the sustained winds and wind gusts at the action location. Additional parameters that may be added to the table include, but are not limited to, maximum speed of winds, rainfall predictions, and probable wind speed.

The benefit of the worst case scenario is that it gives the recipient an estimate of the worst effect any storm may bring to any of the recipient's action locations. If the recipient prepares for the worst case scenario, it is likely the recipient would have implemented all of the action plans prior to the arrival of the wind field of the cyclone.

The recipient may receive the worst case scenario in any medium. For example, the scenario may be sent to the client by any of the following including, but not limited to, via email, phone, pod-cast, fax, mail, television, websites. In one example, a personal web page or website is set up for the recipient. The web page may graphically depict the area impacted by the cyclone and include the scenario for each of the recipient's action locations. The web page may optionally be password-protected for the specific client.

As with any of the methods described herein, once the recipient has received the worst case scenario, more support may be given to the recipient to ensure the safety of each of the recipient's action locations.

Storm Decision Guide

In the preparation for storms, a recipient may have the need for specific support for a particular action location. One concern when a cyclone threatens a location is the time it takes to safely cease, or shut down the action location and/or evacuate the action location. This time is called a critical time T, or action time, and may be different for every action location and every recipient. In one example, the action location is an offshore drilling rig. The critical time T needed to safely shut the operation down, is the time required to safely stop the drilling and/or production operation on the platform and secure and/or evacuate the personnel. This critical time T could be any amount of time from minutes to 10 days depending on the complexity of the operations and the number of personnel at the action location. Typically the critical time T is between several hours and 10 days. The critical time T is often 3-5 days or longer. The potential for rapid cyclone development means that properly warning a recipient before the critical time T is reached requires a tracking of all weather conditions or significant disturbances before they become cyclones. A significant disturbance may be any weather condition that has the potential to develop into a cyclone in the future including, but not limited to, a hurricane, a tropical storm, a tropical depression, a subtropical storm, or a subtropical depression. Thus, the significant disturbances will be classified and monitored as described above, if the significant disturbance has the potential to develop into a cyclone, the significant disturbance is monitored and classified. When a cyclone is forecasted to pass proximate the action location, a decision will need to be made before the time T has passed in order to safely secure the action location. This may be before it is clear whether the cyclone will even impact the action location or whether a significant disturbance may even develop into a tropical cyclone. The storm decision guide forecasts the cyclone's impact and effects based on the critical time T.

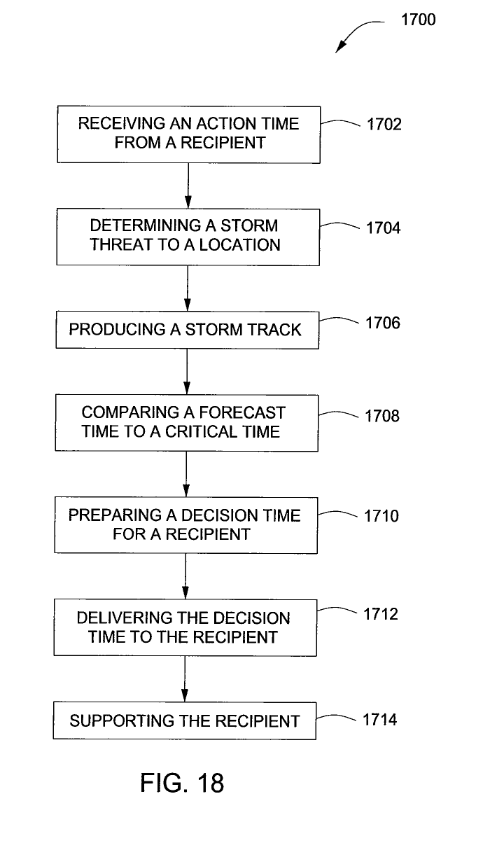

FIG. 18 is a flowchart depicting the weather condition indicating method 1700. The first step is receiving an action time from a recipient 1702. The next step is determining a storm, or cyclone, threat 1704. If there is not a threat of a significant disturbance developing into a cyclone, for example a tropical depression, tropical storm, or hurricane, then the next step is return to step 1702. If the significant disturbance has a probability of developing into a cyclone, then the next step is preparing a storm track 1706 for a period of time in the future. The next step is comparing the forecast time of the storm, or cyclone, with the action time to obtain 1708. The next step is preparing a decision time for the recipient 1710. The next step in the method is delivering the decision time to the recipient 1712. The last step in the method is an optional step of further supporting the recipient 1714.

The first step of the method is receiving an action time from a recipient 1700. This action time may be updated on a regular basis, for example daily or whenever the recipient's action time changes. Because the action time, or critical time T, is different for every action location and for every recipient, a different critical time T, or decision time must be determined for each of the action locations. The recipient may simply provide the information for storage in a database, or the critical time T may be entered into a web-based interface, further a detailed analysis may be done to determine the critical time T for each action location. With the critical time T provided by the recipient for each of the action locations, the method may be continued.

The next step is determining the cyclone threat to the action location 1704. This may be performed in the same manner as described above and/or in conjunction with FIGS. 7, 11, and 15.

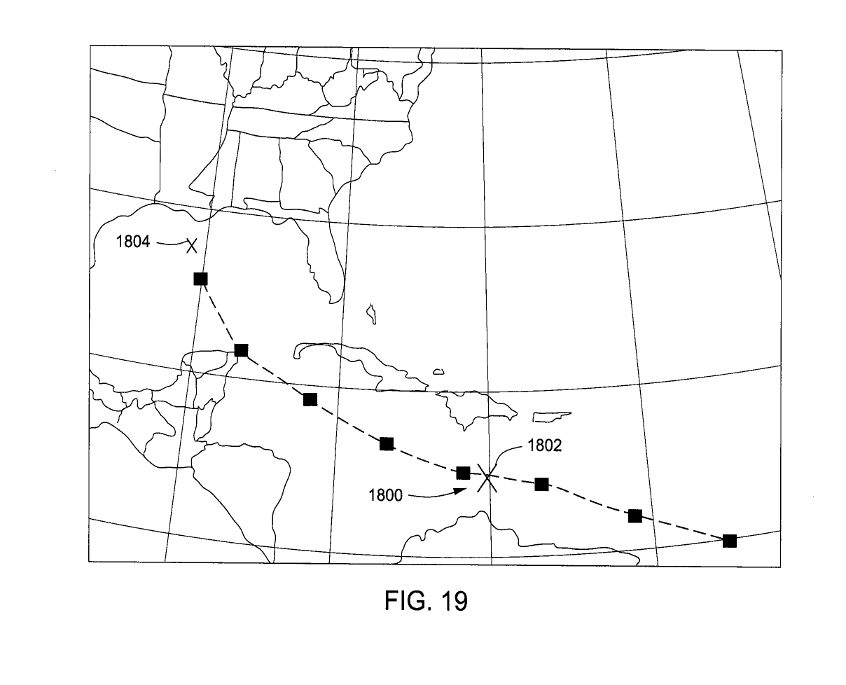

The next step of preparing a storm track 1706 is performed in the same manner as described above. FIG. 19 shows a storm track 1800 according to one method of the storm decision guide. The storm track 1800 is a forecast that indicates the position of the storm center as a function of time from the forecast initialization. It should be appreciated that the storm track 800 may begin at any time before or after the cyclone develops. The storm track 800 is the forecasted track of the significant disturbance or cyclone for a period of time in the future. The storm track may optionally include or incorporate a cone of uncertainty and/or a wind field forecast as described above.

The next step of comparing the forecast arrival time of the wind fields with the action time to obtain 1708. This step involves determining the forecasted time Tf before the significant disturbance or cyclone reaches a critical time location 1802 for a particular action location 1804, shown of FIG. 18. This time Tf may be predicted using the projected forward, or travel, speed of the significant disturbance or cyclone to determine the time from the current location of any wind field to the critical time location 1802. The forecasted projected forward speed for the significant disturbance or cyclone may be based on any of the methods described herein, including but not limited to the forecasted travel speed, the maximum travel speed, the minimum travel speed or any combination of speeds between these speeds, and/or a variable speed storm. Further, any factor of safety may be incorporated into the speed to increase or decrease the time Tf. Further, any of the methods described in the worst case scenario section may be used to calculate the time Tf.

The following step is preparing a decision time left for the recipient 1712. This step simply involves determining the time when one of the wind fields or the storm's center will reach the critical location 1802, or a point near the location if the storm veers off of the track. This may be done using any of the forecasting methods described above. The decision time Td may be reached when any part of the storm reaches the critical location 1802, for example the center of the storm, and/or the tropical storm-force winds. The decision time Td may be the time the recipient has at the action location 1804 before the critical location 1802 is reached by a particular wind field. This is the time the recipient has to make a decision as to whether an evacuation or securing of the action location 1804 needs to take place before a particular wind field reaches the critical location 1802.

The following step is delivering the decision time Td to the recipient 1712. The recipient may receive the decision time Td by any of the methods described herein. For example, the decision time Td may be sent to the client by any of the following including, but not limited to, via email, phone, pod-cast, fax, mail, television, websites. In one example, a personal web page or website is set up for the recipient. The web page may graphically depict the area impacted by the potential cyclone and include the scenario for each of the recipient's action locations. The web page may optionally be password-protected for the specific client.

The final and optional step is supporting the recipient 1714. This step involves any additional support required by the recipient to further assist the recipient with regard to any and all action locations, as described above.

The decision time Td may be delivered to the recipient in any form. In one example the decision time Td is simply a time countdown. The time countdown may include a current decision time represented in numerical form, for example Td=66 hours. The time countdown may continuously, or incrementally countdown until the critical time T is reached. This would allow for continuous, or incremental adjustment of the decision time Td based on changes in the forecast track. Further, the decision time may simply be a time and date at which the critical time T is predicted to occur. For example, the critical time will occur at 10:30 pm on July 7^{th}. Further, any method may be used to indicate to the recipient what the decision time is. In conjunction with the decision time, the recipient may receive other critical information including, but not limited to, the current location of the action location, the current time, the current critical time T, the location of the significant disturbance or cyclone, the distance between the significant disturbance or cyclone and the action location, the forward speed, the probability of significant disturbance developing into a cyclone, the probability of hurricane development, the location of the decision time, the distance between the critical location and the action location, and the time before cyclone impact.

It should be appreciated that any of the methods described herein may be used in conjunction with the storm decision guide.

Investment Decisions

A method of predicting future commodity prices may be based on the methods described herein. When tropical cyclones pose a threat to business operations at a location the present or future price of commodities associated with that business may be impacted. For example, if a tropical cyclone is approaching one or more offshore oil operations in the Gulf of Mexico, the price of oil, or oil futures may increase. This may be the case for any industry including, but not limited to, the produce industry, refining and chemical plant operations, and manufacturing. The methods described herein may be used to predict the impact on the industry and/or commodity in the path of the tropical cyclone. An accurate prediction of price increase and/or decrease may then be determined.

The methods described herein may further be used in combination with future weather predictions. For example, the methods described herein may be used in conjunction with or in addition to climate models or statistical averages of weather, globally or at a specific location. The methods may be applied to past storms in order to compute averages from years past. The historical data may then be used for future weather and/or climate forecasts.

Insurance Decisions

A method of arriving at insurance decisions based on methods described herein may be contemplated. For example, an “insurance index” may be derived from a method described herein. Based on historical, present and/or future data from storms using one or more of the methods described herein, an insurance index may be derived. An insurance index may be used to measure the likelihood of damage from a one or more of the methods described herein. Thus, based on data and/or probability of future storms, insurers may prepare a number of insurance indices based on the methods herein, such as but not limited to: policy quotes, damage estimates, damage predictions, risk associated with the location, actuary tables.

The insurer may formulate an index for future damage based on historical damage created by storms. An existing storm can be indexed. The existing storm can be compared with the historical data. The insurer can then estimate the damage created at the probable landfall location. The insurer can include additional information to further assist in the estimate such as, but not limited to: the population at the landfall location, the probability of flooding at the location, the type of structures associated with the location, and possible industries to be affected at the location.

The insurer may locate personnel, and/or insurance adjusters, at a location based on any of the methods described herein. For example, if there is a high probability of impact and/or the storm index is a large number, a large number of personnel may be positioned at the location in order to assess the damage at the location after impact. The amount of personnel may be a direct function, or a non-linear function, of the storm index. Further, any of the methods described herein may be used to estimate the number of personnel and/or adjustors at a location.

It should be appreciated that all of the methods described herein may be used in conjunction with one another.

1. A method of indicating a weather condition, the method comprising:
providing a probability of a wind field from a cyclone impacting one or more locations over a period of time; and
delivering the probability of the wind field impact to a recipient.

2. The method of claim 1, wherein the wind field comprises a probability one or more wind zones impacting the recipient wherein the wind zones are determined by one or more wind speeds within the cyclone.

3. The method of claim 1, further comprising providing a first probability parameter related to the wind field to the recipient, wherein the wind field comprises one or more probabilities of a wind speed intensity for the storm.

4. The method of claim 1, further comprising providing a first probability parameter related to the wind field to the recipient, wherein the first probability parameter is the probability of a particular wind speed impacting that location.

5. The method of claim 1, further comprising providing a first probability parameter related to the wind field to the recipient, and providing a second probability parameter related to the wind field to the recipient.

6. The method of claim 1, further comprising providing a first parameter and a second probability parameter to the recipient, wherein the second probability parameter includes an indication of the relative change in the probability of a particular wind speed impacting that location since the last forecast.

7. The method of claim 1, further comprising providing at least three probability parameters to the recipient wherein at least one of the probability parameters is a maximum possible probability of a particular wind speed impacting that location.

8. The method of claim 1, wherein delivering to the recipient further comprises displaying the probability on a website.

9. The method of claim 1, wherein delivering to the recipient further comprises displaying the probability on a website, wherein the website is password protected and accessible only by a specific recipient.

10. A method of indicating a weather condition, the method comprising:
indexing a cyclone based on two or more parameters to provide a storm index;
providing an impact area of the cyclone based on the storm index;
providing a wind field associated with the impact area based on the storm index;
providing a probability of the wind field impacting a recipient over a time period; and
delivering the probability of the wind field impact to the recipient.

11. The method of claim 10, wherein delivering the probability includes at least three probability parameters, wherein one of the probability parameters includes a numerical value indicating the numerical probability of impact at a location.

12. A method of preparing an insurance index, the method comprising:
providing a probability of a wind field from a cyclone impacting one or more locations over a period of time;
delivering the probability of the wind field impact to a recipient; and
preparing an insurance index based on the probability of impact.

13. The method of claim 12, wherein the insurance index includes a damage estimate of a location.

14. The method of claim 12, wherein the insurance index includes a risk associated with a location.

15. The method of claim 12, wherein the insurance index includes a policy quote.
